(19) United States
(12) Patent Application Publication
(10) Pub. No.: US 2010/0083674 A1
(43) Pub. Date: Apr. 8, 2010

(54) METHOD AND SYSTEM FOR WATER COOLED SUB-COOLER IN WATER PRODUCTION DEVICE

(75) Inventor: Thomas MERRITT, Hollywood, FL (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: ISLAND SKY CORPORATION, Hollywood, FL (US)

(21) Appl. No.: 12/564,568

(22) Filed: Sep. 22, 2009

Related U.S. Application Data
(60) Provisional application No. 61/102,120, filed on Oct. 2, 2008.
(60) Provisional application No. 61/184,956, filed on Jun. 8, 2009.

(51) Int. Cl. F25D 21/14; F25D 13/00; F25B 1/00; F16K 17/38

(52) U.S. Cl. 62/93; 62/291; 62/430; 62/498; 137/468

(57) ABSTRACT

An apparatus and method for condensing water vapor in air to extract liquid water includes a refrigeration system having a cooling element and a refrigerant sub-cooler. The refrigeration system may have a cooling element with an exterior cooling surface over which air passes to shed heat and reach a lower temperature. The air has a dew point, and the cooling surface is at that dew point or less, causing liquid water to condense on the cooling element. The resulting liquid water may be caught in a water basin. The sub-cooler is immersed in liquid water collected in the water basin, to shed heat from refrigerant inside the sub-cooler.

### CROSS-REFERENCE TO RELATED APPLICATION

This application claims priority to U.S. Provisional Application Ser. No. 61/102,120, entitled “Methods and Systems for Potable Water Production,” filed Oct. 2, 2008, and to U.S. Provisional Application Ser. No. 61/184,956, entitled “Method And System For Water Recovery From Air Using Combined Receiver And Water Cooled Condenser,” filed Jun. 8, 2009, the entirety of both of which are incorporated herein by reference.

### STATEMENT REGARDING FEDERALLY SPONSORED RESEARCH OR DEVELOPMENT

Not applicable.

### FIELD OF THE INVENTION

The present invention relates generally to production of water, and more specifically to improved systems and methods for extracting water from water vapor, for example from the atmosphere.

### BACKGROUND OF THE INVENTION

Ambient air naturally contains some quantity of water vapor, so the general atmosphere is a potential water source. Extracting this water from the surrounding atmosphere presents several challenges. Other attempts to produce water from atmospheric air have typically fallen short of the desirable criteria, including efficiency in the amount of water produced per the amount of energy used, extracting the greatest possible percent of the moisture available in the air under local conditions, and producing acceptable quantities of water at all times of day and in various weather, seasons, and climates. Therefore, atmospheric water vapor is an essentially untapped source of greatly needed water supplies that is potentially available worldwide.

Refrigeration systems have been known for some time. Vapor-compression cycle refrigeration systems are most common today, but other types of refrigeration are possible including gas absorption and heat pumps. A refrigeration system may provide one or more closed-loop circuits for a refrigerant medium. If the refrigeration system uses a vapor-compression cycle, it may include a compressor, evaporator, expansion valve, and condenser.

Diagrams of an example vapor compression refrigeration system, and its thermodynamic operation, are shown in FIGS. 10-12. For example, a compressor may compress a refrigerant from a saturated vapor state to a superheated vapor state. A condenser may then remove the superheated condition from the refrigerant vapor, and then condense the refrigerant to a saturated liquid state. Across an expansion valve, the refrigerant may become mixed states of liquid and vapor. And an evaporator may convert the refrigerant back to saturated vapor. During this cyclical process, an external surface of the evaporator will become cold. Some form or variation of this process may be used in refrigerators, freezers, and air conditioning systems.

Most refrigeration systems have some cooling element, through which air passes to shed heat and reach a lower temperature. In a vapor compression cycle refrigeration system, the cooling surface of the cooling element will be an exterior surface of the evaporator. An evaporator having a temperature of at most a dew point of air contacting the evaporator will cause liquid water to condense on an exterior surface of the evaporator.

Whenever this cooling element has a temperature at or less than the local dew point of the air, water vapor in the air will tend to condense into droplets of liquid water. When a cooling element has a temperature at or less than the freezing point of water, such as in a freezer, water vapor in the air will tend to condense and then freeze into ice.

In most residential and commercial refrigeration systems, this condensation is considered undesirable, and some refrigeration systems even have features for ameliorating them. However, the principles causing such condensation can be used to produce liquid water from water vapor in atmospheric air.

Exemplary methods of water production and accompanying apparatus are described in U.S. Pat. No. 6,343,479, entitled “Potable Water Collection Apparatus” which issued on Feb. 5, 2002, and U.S. Pat. No. 7,121,101, entitled “Multipurpose Adiabatic Potable Water Production Apparatus And Method” which issued on Oct. 17, 2006, the entire contents of both of which are incorporated by reference.

These patented methods and devices present viable means of extracting liquid water from atmospheric air, including apparatus for transforming atmospheric water vapor into potable water, and particularly for obtaining drinking quality water through the formation of condensed water vapor on surfaces maintained at a temperature at or below the dew point for a given ambient condition. The surfaces upon which the water vapor is condensed are kept below the dew point by a refrigerant medium circulating through a closed fluid path, which includes refrigerant evaporation apparatus, thereby providing cooling of air flowing through the device, and refrigerant condensing apparatus to complete the refrigeration cycle.

It is desirable to increase efficiency of a water production system by increasing the efficiency of an associated refrigeration system, and to provide efficient and economical water production during conditions when the ambient wet bulb and dry bulb temperatures indicate high relative humidity or less than ideal atmospheric conditions.

### SUMMARY OF THE INVENTION

The present invention advantageously provides a system, device and method for extracting water from air using a refrigerant sub-cooler that is cooled by the liquid water collected from the evaporator. This arrangement advantageously allows the liquid refrigerant to be maintained at a lower temperature as compared with ambient air to therefore increase operational efficiency.

In accordance with one aspect, the present invention provides an apparatus for extracting water from air. A refrigeration system defines a closed-loop path for a refrigerant. The refrigeration system includes an evaporator and a sub-cooler. The evaporator is operable to cause liquid water to condense on an exterior surface of the evaporator. A water basin defines an inner volume and is positioned proximate to the evaporator for collecting water from the exterior surface of the evaporator. The sub-cooler is positioned inside the inner volume of the water basin. A mechanism may be provided to maintain a selected water level in the water basin so that the sub-cooler remains submerged in water during operation.

The sub-cooler may thus increase the operating efficiency of the water production system as compared with a system that does not use a water cooled sub-cooler. The operating efficiency may be measured as either an amount of water condensed on the evaporator's exterior surface per time, or an amount of water condensed per input energy.

In accordance with another aspect, the present invention provides an apparatus for extracting water from air. A refrigeration system defines a closed-loop path for a refrigerant. The refrigeration system includes an expansion valve, an evaporator operable to cause liquid water to condense on an exterior surface of the evaporator, a compressor, a de-superheater, a condenser and a sub-cooler. A water basin is positioned proximate to the evaporator for collecting water. The sub-cooler is positioned within the water basin such that the sub-cooler is submerged in collected water during operation. A water-level maintaining mechanism is operable to maintain a predetermined amount of collected water in the water basin.

In accordance with still another aspect, the present invention provides a method of extracting water from air using a water production system. The water production system includes a water basin and a refrigeration system having a cooling element and a sub-cooler. Air is caused to flow and contact the cooling element. The refrigeration system is operated to cause the cooling element to maintain a temperature of at most a dew point of air contacting the cooling element. Liquid water is condensed from the air on an exterior surface of the cooling element. The liquid water is collected to submerge the sub-cooler in water in the water basin.

The elements of a water production system according to the present invention may be selected from among many different suitable materials having the desired physical properties. Some of these characteristics may include for example strength, thermal insulation or transmission, corrosion resistance, and material performance in a broad range of temperatures and pressures. Acceptable materials may include metals such as for example copper, aluminum, steel, stainless steel, as well as polymers.

A more complete understanding of the present invention, and its associated advantages and features, will be more readily understood by reference to the following description and claims, when considered in conjunction with the accompanying drawings.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagrammatic side view of an exemplary water production system with a water cooled sub-cooler, constructed in accordance with the principles of the present invention;

FIG. 2 is a diagrammatic side view of an exemplary water production system with water cooled sub-coolers, constructed in accordance with the principles of the present invention;

FIG. 3 is a diagrammatic side view of an exemplary water production system with a water cooled sub-cooler, constructed in accordance with the principles of the present invention;

FIG. 4 is a partial perspective view of an exemplary water production system constructed in accordance with the principles of the present invention;

FIG. 5 is a partial perspective view of an exemplary water production system constructed in accordance with the principles of the present invention;

FIG. 6 is a diagrammatic top view of the exemplary water production system of FIG. 4;

FIG. 7 is a diagrammatic side view of the exemplary water production system of FIG. 4;

FIG. 8 is a partial exploded view of refrigeration system components of an exemplary water production system, constructed in accordance with the principles of the present invention;

FIG. 9 is a partial exploded view of refrigeration and structural components of an exemplary water production system, constructed in accordance with the principles of the present invention;

FIG. 10 is a psychrometric chart of water, showing the physical properties of moist air at sea level;

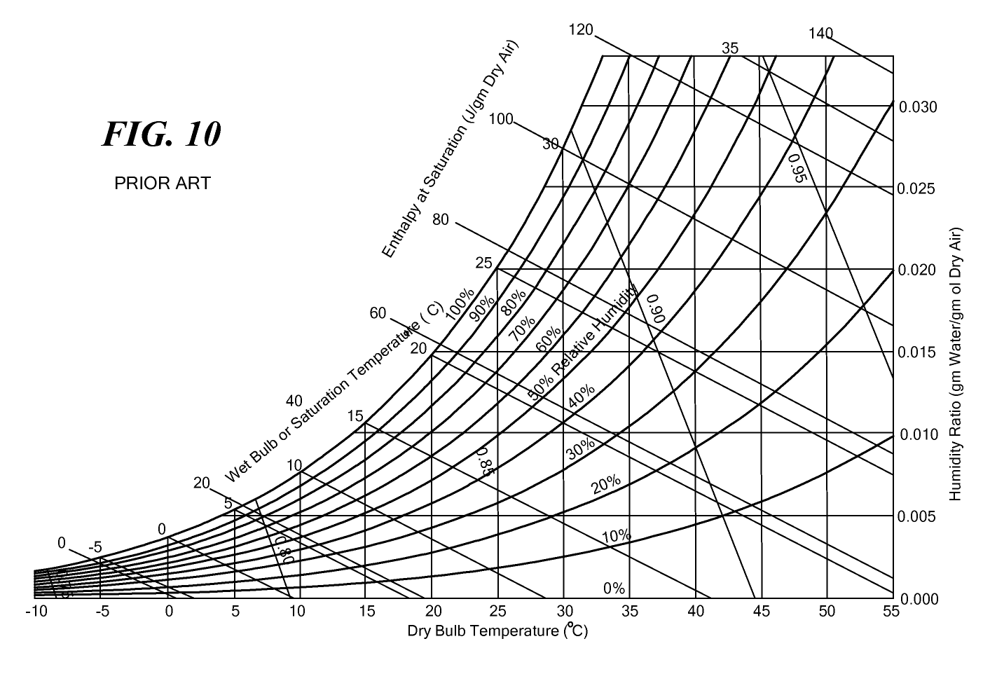

FIG. 11 is a representative diagram of temperature and entropy for an exemplary refrigerant; and

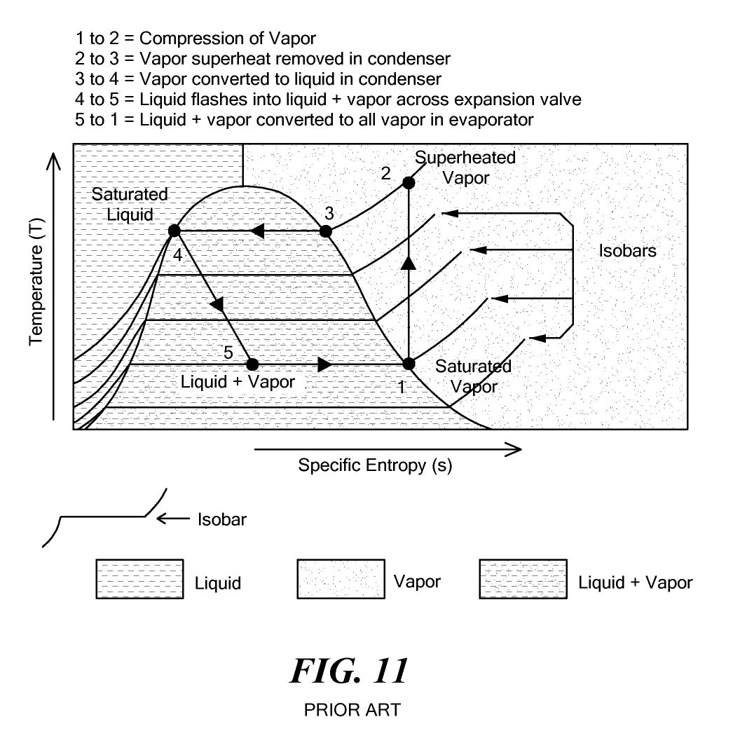

FIG. 12 is a representative diagram of a known refrigeration system.

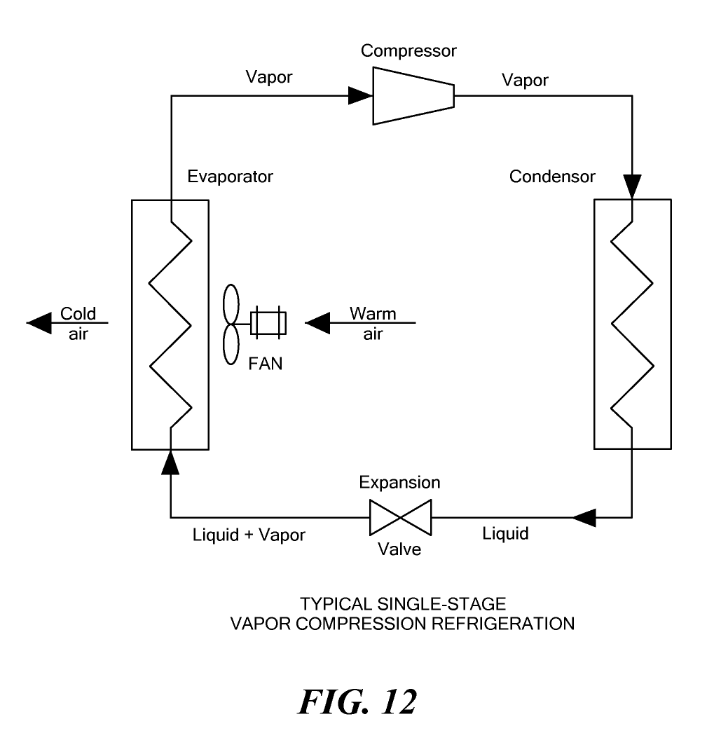

### DETAILED DESCRIPTION OF THE INVENTION

The present invention advantageously provides an improved system and method for extracting water from water vapor, for example from the atmosphere. The water production system of the present invention may have various sizes, arrangements and features.

Some aspects of the present invention relate to combinations of components and method steps for implementing systems and methods to improve the efficiency and operation of water production systems. Accordingly, some components have been represented where appropriate by conventional symbols in the drawings, showing only those specific details that are pertinent to understanding the embodiments of the present invention, so as to avoid details that will be readily apparent to those of ordinary skill in the art having the benefit of this description.

Relational terms, such as “first” and “second,” “top” and “bottom,” and the like, may be used solely to distinguish one entity or element from another entity or element, without necessarily requiring or implying any physical or logical relationship or order between such entities or elements.

Referring to the drawings, various embodiments of water production devices are illustrated. The illustrations of course depict only some of many different possible designs that are within the scope of the present invention. In particular, the present invention encompasses water production systems having numerous combinations of elements, and the description of any element also contemplates providing more than one of that element. For clarity and convenience, the present detailed description will only describe a few specific embodiments of the present invention.

An apparatus for extracting water from the water vapor in atmospheric air may generally include a refrigeration system having a cooling element and a sub-cooler, with a water basin for collecting water as it condenses on the cooling element, in which the sub-cooler is submerged. The cooling element has a temperature of at most a dew point of air contacting the cooling element, so that liquid water condenses on an exterior surface of the cooling element.

The refrigeration system may be of various types, including vapor-compression cycles, gas absorption and heat pumps. Regardless of which type of refrigeration system is chosen, the refrigeration system should have at least one cooling element, with an exterior cooling surface. During operation, the cooling surface is maintained at a temperature which is at or less than a dew point of air. In other words, atmospheric air flowing through a water production system can contact a cooling element of a refrigeration system having a temperature of at most the dew point, to cause liquid water to condense on a cooling surface.

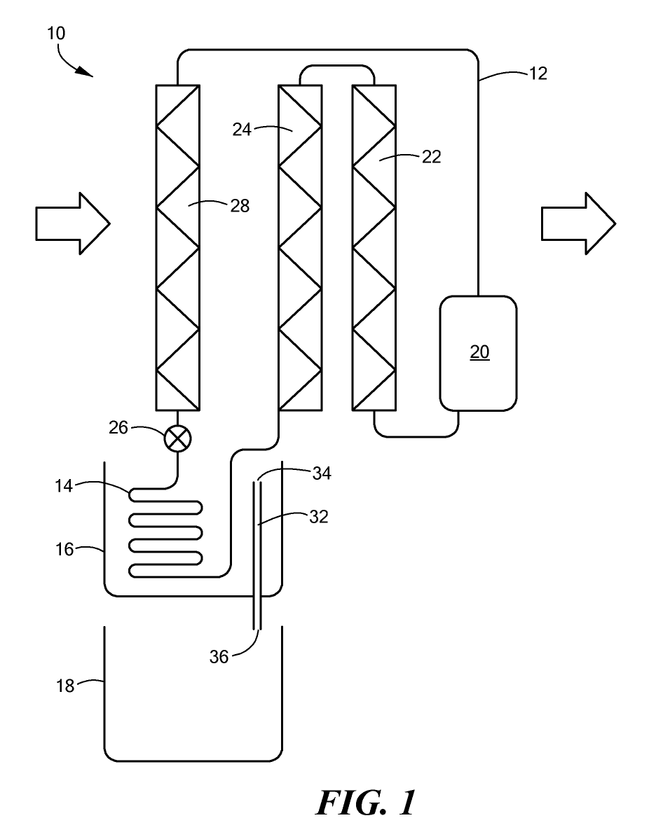

With specific reference to the drawings, in which like reference designators refer to like elements, an exemplary diagram of a water production system according to the present invention is shown in FIG. 1, and is generally designated as “10.” In this particular illustrated example, water production system 10 has a refrigeration system 12 including a sub-cooler 14, a water basin 16, and a water collection vessel 18.

The refrigeration system 12 of the present invention may be of any suitable type, and may have various arrangements of refrigeration components. If the refrigeration system is of the vapor-compression type, it may include for example at least one compressor, evaporator, expansion valve, and condenser. The refrigeration system may provide one or more closed-loop circuits for a refrigerant medium.

In the diagram of FIG. 1 for example, a refrigeration circuit may be arranged from a compressor 20, to a first condenser 22, to a second condenser 24, to a sub-cooler 14, to an expansion valve 26, to an evaporator 28, and back to the compressor 20. A refrigerant medium may proceed in a closed-loop path around the components and conduits of the refrigeration system.

For example, a refrigerant in a saturated liquid state may cross expansion valve 26, becoming mixed states of liquid and vapor. Evaporator 28 may then convert the refrigerant back to saturated vapor. An external surface of the evaporator 28 may accordingly be cooled to a temperature at or below the local ambient dew point of air, which will tend to cause liquid water to condense from water vapor in the air. The resulting cooled liquid water will tend to condense and fall from the evaporator 28, into water basin 16.

Continuing a refrigeration cycle description, the compressor 20 may then compress refrigerant from a saturated vapor state to a superheated vapor state. The first condenser 22 may then remove the superheated condition from the refrigerant vapor, thus acting as a de-superheater. The second condenser 24 may then condense the refrigerant to a saturated liquid state. Then, sub-cooler 14 of the present invention uses water in the water basin 16 to further cool the saturated liquid refrigerant. The sub-cooler 14 may thus serve as a reservoir for liquid refrigerant until needed, based on demand through the expansion valve.

Passing the tubing of the sub-cooler through water transfers heat from the refrigerant inside the sub-cooler by conduction, and by some water flow through the water basin into the water collection vessel, rather than merely by convection alone with the air. Also, water in the water basin will tend to have a temperature lower than the ambient air temperature, having fallen from condensation in contact with the cooler external surfaces of the evaporator. Accordingly, the water in the water basin is even more effective than ambient air, for example, to cool the refrigerant inside the sub-cooler.

The sub-cooler may have various desired arrangements, such as for example a conduit or tube having any suitable shape, including straight, curved, undulating, convoluted, sinusoidal, coiled, spiral, etc. The sub-cooler may also have either a two-dimensional or three-dimensional shape or pattern. If desired, a sub-cooler may have bends that are smooth and arcuate, to facilitate flow of refrigerant through it. Also, it may be desirable to provide a convoluted shape of some kind, to maximize the external surface area of the sub-cooler in contact with water in the water basin. Such a larger surface area will tend to consequently maximize heat transfer from the refrigerant inside the sub-cooler to the water in the water basin.

Accordingly, the sub-cooler of the present invention may increase efficiency of the refrigeration system, and lower operating costs of the water production system. This operating efficiency may of course be measured in various ways. For example, efficiency may be measured as an amount of water condensed on the exterior surface of the evaporator(s) per time.

In another possible example, with a given source of input energy for operating the water production system, the operating efficiency may be measured as an amount of water condensed on the exterior surface of the evaporator(s) per input energy.

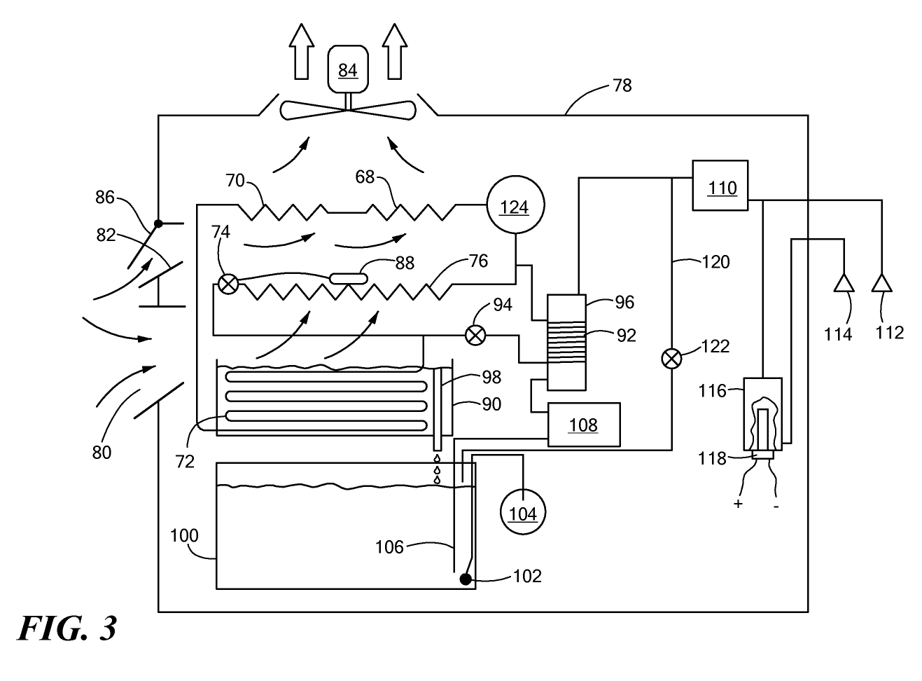

By way of example, an exemplary compressor 124 (FIG. 3) used in a prototype test environment for the present invention was manufactured by Emerson Climate Technologies. The technical data sheet of the compressor published by the manufacturer provided expected performance under two sets of conditions. The first set of conditions provides: evaporator temperature 45° F. (7.2° C.), condenser temperature 130° F. (54.4° C.), return gas (refrigerant) temperature 65° F. (18.3° C.) and liquid refrigerant temperature 115° F. (46.1° C.). Under these conditions the expected capacity of the compressor is 125,000 BTU per hour. The second set of conditions provides: evaporator temperature 45° F. (7.2° C.), condenser temperature 100° F. (37.8° C.), return gas (refrigerant) temperature 65° F. (18.3° C.) and liquid refrigerant temperature 85° F. (29.4° C.). Under these conditions the expected capacity of the listed compressor is 148,000 BTU per hour, an increase in capacity of 23,000 BTU per hour. In other words, according to the manufacturer, the second set of conditions provides nearly 2 additional tons of capacity as compared with the first set of conditions. The manufacturer further provides data indicating electrical performance under these above conditions, i.e. current draw, power consumption, and Energy Efficiency Rating (EER) which translates to BTU per watt hour. With respect to the first set of conditions, the expected current draw is 32.9 A and the EER listed as 11.4. With the second set of conditions, the expected current draw is 26.7 A, a 6.2 Amp reduction as compared with operation under the first set of conditions, and the EER listed as 19.1, nearly double the EER as compared with operation under the first set of conditions.

During a test of an exemplary system constructed in accordance with the present invention in which ambient air is approximately 90° F. (32.2° C.) and 60% relative humidity, the evaporator temperature was measured at 56° F. (13.3° C.). This was 10° F. (5.6° C.) higher than preferred in the manufacturer's data sheet. Offsetting this increase was a drop in condensing temperature which averaged 75° F. (23.9° C.). The actual return gas refrigerant temperature was measured at 56° F. (13.3° C.) and the liquid refrigerant temperature was measured at 79° F. (26.1° C.), 6° F. (3.3° C.) below the ideal published number, and 11° F. (6.1° C.) below the ambient temperature. The current drawn was measured at 26 A., agreeing with the compressor manufacturer's predictions, thereby yielding an EER of 19.1.

The manufacturer does not list any data which would indicate any further increase in performance with respect to these lower numbers, however it is clear from these results that the water-cooled sub-cooler provides operational efficiency. Accordingly, as a direct result of the sub cooling device and method described herein, evaporators of larger surface area can be matched with compressors of lesser capacity, with the increase in compressor performance making up the difference.

The water basin may also be fitted with a mechanism for maintaining a desired amount of water in the water basin, so that the sub-cooler remains submerged. Such a water-level maintaining mechanism may have any suitable configuration, including a float-actuated device, servo mechanism, or the illustrated example of a drain tube 32. Drain tube 32 may be arranged vertically, with an inlet port 34 inside the water basin at an elevation or a vertical position above the sub-cooler, and an outlet port 36 opening above the water collection vessel 18.

Accordingly, water basin 16 will tend to initially fill with water until the level reaches the elevation of the drain tube 32 inlet port, which is vertically positioned to completely submerge the sub-cooler in water. Additional water will then tend to drain into the inlet port 34, through drain tube 32, exiting from outlet port 36 and into water collection vessel 18.

As indicated by the arrows in FIG. 1, air flow may be provided to or by the water production system, passing through the refrigeration system and particularly through the evaporator and condensers. Of course, the air flow may be natural or forced, with or without an air movement device such as a fan.

Another embodiment of the present invention may provide one or more additional refrigeration systems. For example, a water production system may include more than one refrigeration system.

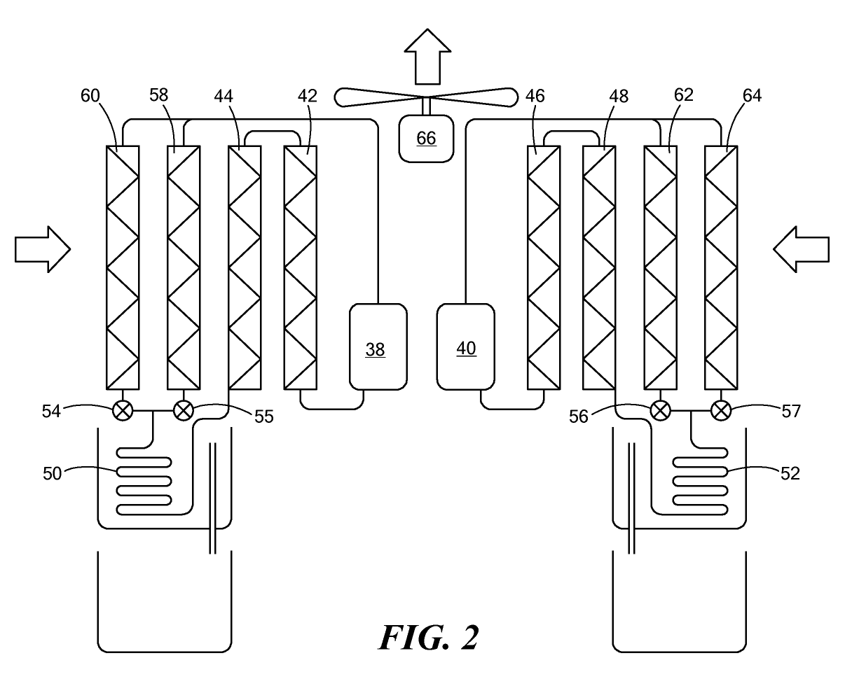

For example, the embodiment of a water production system shown in FIG. 2 provides a first and second refrigeration system, each arranged in a similar fashion and defining separate closed-loop refrigerant paths. The two refrigeration systems include two compressors 38 and 40, two matching pairs of evaporators 58, 60, 62 and 64, two water cooled sub-coolers 50 and 52, two pairs of expansion valves 54, 55, 56, and 57, and two pairs of condensers 42, 44, 46 and 48. An air movement device such as a fan 66 may be used to cause air flow, for example in the direction of the arrows in FIG. 2.

FIG. 3 depicts another particular embodiment of an exemplary water production system for extracting potable water from the atmosphere, including a compressor 124, a first condenser 68 and a second condenser 70, a water cooled sub-cooler 72, an expansion valve 74, and one or more evaporators 76. First condenser 68 may perform the role of a de-superheater. A housing 78 may include an air inlet 80 and an air bypass inlet 82, into which ambient air may be pulled by way of a fan 84. The air is then evacuated at an exit opening in the housing 78 where the fan 84 is generally positioned. The amount of bypass air introduced into the housing 78 through the air bypass inlet 82 relative to the air flowing into inlet 80 may be controlled and modulated by a valve or damper 86. In one embodiment, damper 86 may be operated by a stepper motor, servo, or other controller, which in turn may be manually controlled or coupled with a microcontroller to cause the operation and adjustment of damper 86 based on environmental or other conditions.

Bypass inlet 82 and the associated damper 86 may be physically located between the condenser 70 and the evaporator 76. At lower temperatures, the damper may be closed, thereby allowing more air to flow over evaporator 76. At higher temperatures, the damper 86 may be opened, allowing more air over condensers 68 and 70 in comparison to the amount of air flowing over evaporator 76. Less air flowing over evaporator 76 means a lowering of the temperature of the refrigerant in evaporator 76. With damper 86 open, the needed air pressure may drop to about 8 pounds per minute, requiring less energy to operate. If the dimensions of bypass air inlet 82 are made larger relative to air inlet 80, the required air pressure may be able to be lowered to approximately 5 pounds per minute.

Air entering housing 78 through air inlet 80 passes through evaporator 76 and then de-superheater 68 or condenser 70. Evaporator 76, de-superheater 68 and condenser 70 operate as known in the art based on the flow of refrigerant through the refrigeration components. Air entering housing 78 through air bypass inlet 86 passes through de-superheater 68 or condenser 70, and bypasses evaporator 76.

The refrigerant flow of the present invention may be described as follows. Refrigerant is compressed by compressor 124 and flows through a conduit to de-superheater 68 and then condenser 70, where it collects in water cooled sub-cooler 72. The refrigerant then flows through thermostatic expansion valve 74 and through evaporator 76. Thermostatic expansion valve 74 is controlled by temperature sensing bulb 88. Temperature sensing bulb 88 is in contact with the suction line after the evaporator 76, and measures the temperature of the refrigerant leaving evaporator 76. As the temperature of evaporator 76 increases, more refrigerant is needed to effect the extraction of the water from the air by maintaining or lowering the surface temperature of the evaporator 76. As the temperature of the refrigerant exiting evaporator 76 increases, the pressure in temperature sensing bulb 88 increases, thereby exerting pressure on a diaphragm inside the expansion valve 74, which in turn allows increased refrigerant flow through expansion valve 74. This action allows the surface of evaporator 76 to be maintained below the dew point of ambient air at a wide range of ambient air temperatures. In operation, air flowing through the evaporator 76 gives up its heat, thereby causing water vapor within the air to condense on the surface of evaporator 76 and fall into a collecting tray 90.

Water cooled sub-cooler 72 allows additional refrigerant to be stored within the refrigerant path, such that it is readily available for use when conditions require additional refrigerant as noted above. By maintaining collected water in collecting tray 90, water cooled sub-cooler 72 is submerged in water that has been recently condensed, and cooled to a temperature at or near to the temperature of evaporator 76. Water at this cooler temperature increases the efficiency of the water cooled sub-cooler.

The refrigerant flow also includes a path through an auxiliary evaporator 92 via a second expansion valve 94. In operation, this allows some compressed refrigerant to bypass around the evaporator 76, thereby flowing through auxiliary evaporator 92. Auxiliary evaporator 92 may have any suitable shape, including coiled, undulating or convoluted, and surrounds chilled water vessel 96. Water inside chilled water vessel 96 is thereby cooled, and the evaporated refrigerant enters compressor 124 to begin the refrigeration cycle again.

The water extracted from ambient air flows through the water production system shown in FIG. 3 as follows. Water collects in collecting tray 90, and a drain tube 98 may be arranged within collecting tray 90. Accordingly, after the water rises to a predetermined level that is sufficient to submerge the water cooled sub-cooler 72, additional water drains through drain tube 98 and into a water tank 100. An ozone diffuser 102 is supplied with ozone by an ozonator 104, to ozonate the water in water tank 100, which tends to purify it.

A pick-up tube 106 is positioned within water tank 100, such that water can be extracted from water tank 100 and pumped by a water pump 108 into chilled water vessel 96, through a filter 110, and out either a cold water faucet 112 or a hot water faucet 114. Filter 110 can be, for example, a charcoal filter. Water destined for hot water faucet 114 is first collected in a hot water vessel 116 and heated by a heater 118. Heater 118 may be an electric heater controlled by a thermostat (not shown).

As is shown in FIG. 3, the water path of the water production system also includes a return path back to water tank 100 through water return line 120 and valve 122. Valve 122 may be a solenoid or other electrically-operated valve. When there is little or no demand for water from the cold water faucet 112 and hot water faucet 114, valve 122 may be opened so that water may be circulated by water pump 108 from water tank 100, through chilled water vessel 96 and back into water tank 100. This recirculation facilitates the ozonating process and resists bacteria formation in the plumbing lines from water tank 100 to the faucets 112 and 114. Valve 122 can be controlled by a microcontroller or other processor which monitors water demand, for example, by monitoring the water pressure on the outlet side of the pump 108. Other arrangements for monitoring the water pressure to thereby control the valve 122 are also contemplated, and of course the invention is not limited solely to the arrangement described above.

Water production systems of the present invention may also provide an air duct with one or more ports, including an entry port and an exit port. An air movement device may be a fan disposed within the air duct, operable to draw air through the air duct.

If a specific embodiment defines an air duct, an intermediate port may be provided between the entry port and exit port, such that the air duct defines a first and second air flow path. The first air flow path may proceed sequentially through the entry port, evaporator, condenser, and exit port. In contrast, the second air flow path may proceed sequentially through the intermediate port, condenser, and exit port, thus bypassing the evaporator. In other words, with the intermediate port being positioned between the evaporator and condenser, air can enter the air duct: (i) through the entry port and evaporator, and (ii) through the intermediate port, bypassing the evaporator. The air movement device in such embodiments is capable of moving air through the air duct along the first and second air flow paths.

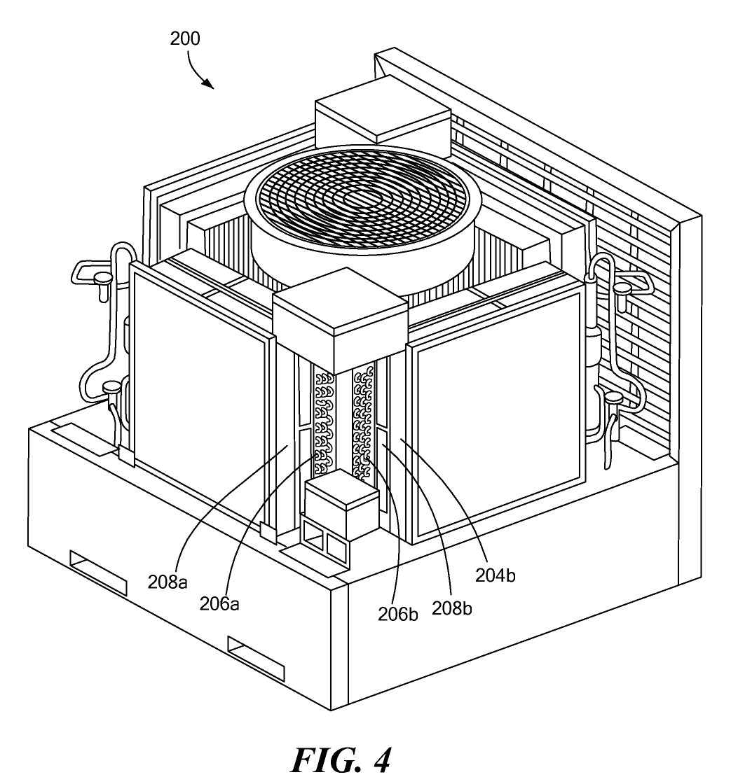

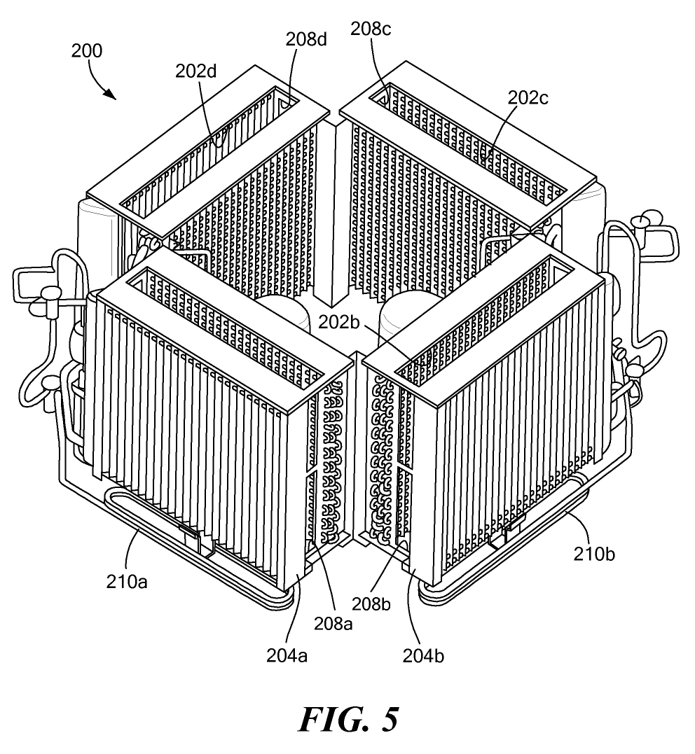

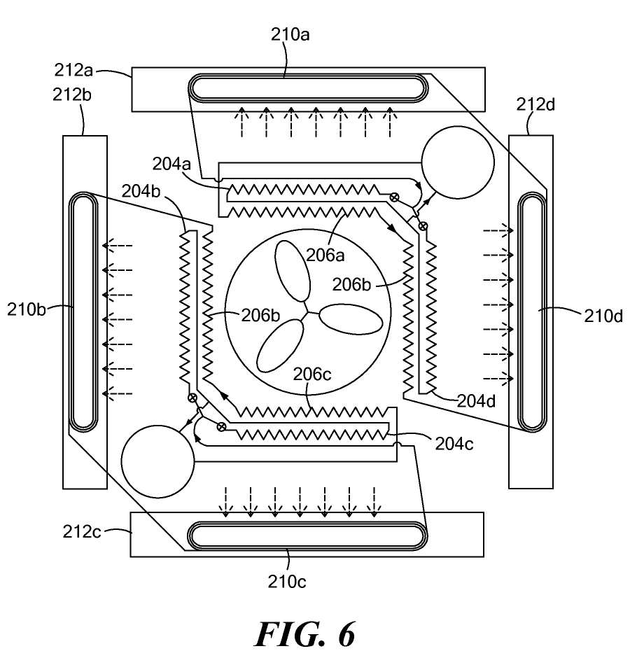

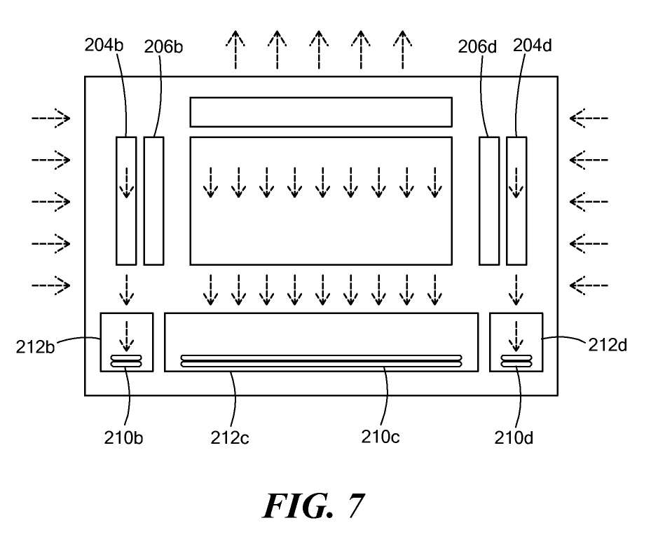

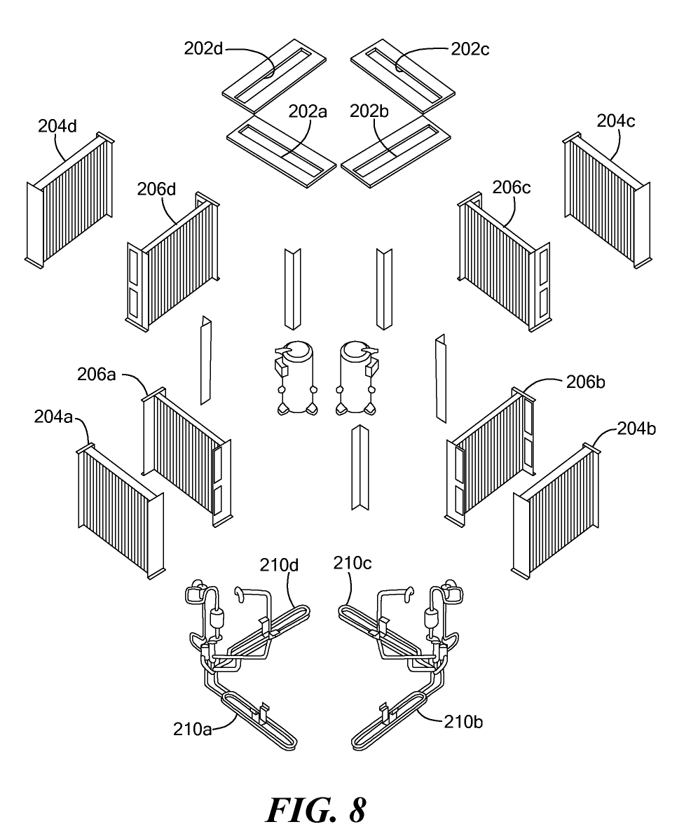

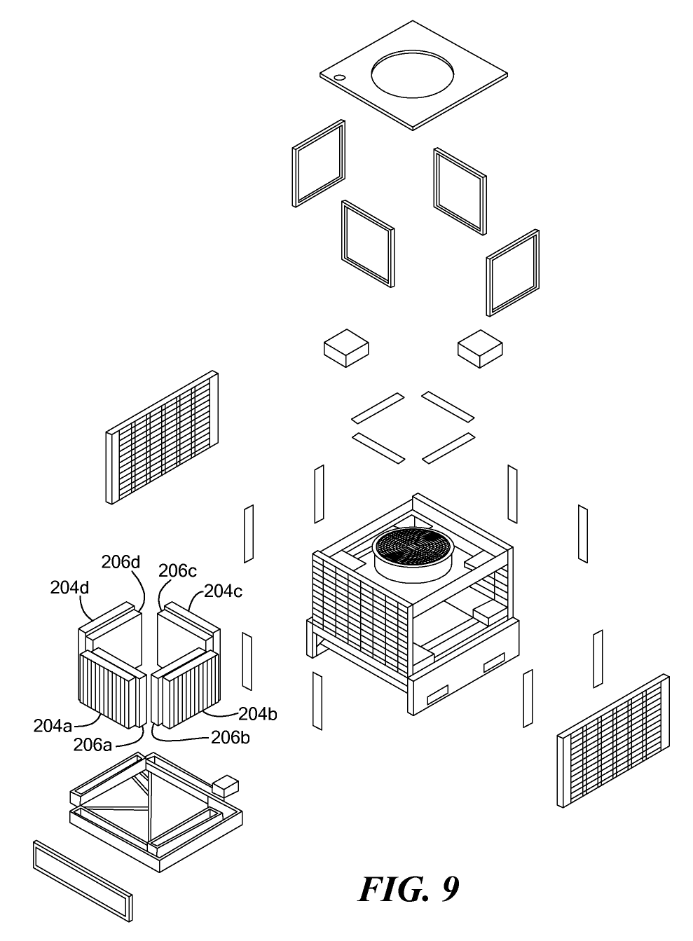

For example, FIGS. 4-9 depict a water production system defining a rectangular air duct having entry ports, intermediate ports, and exit ports. The exit port is positioned at one end of the air duct, and the fan is positioned near the exit port. Water production systems according to the present invention may have one or more bypass ports that remain open, or may be selectively opened and closed, either in a binary or selectively adjustable fashion. The water production system 200 of FIGS. 4-9 has four intermediate ports 202a-d (referred to collectively herein as “intermediate port 202”) defined on the top between each of four evaporators 204a-d (referred to collectively herein as “evaporator 204”) and four condensers 206a-d (referred to collectively herein as “condenser 206”), and at least four additional intermediate ports 208a-d (referred to collectively herein as “additional intermediate port 208”) are defined on both sides of each pair of evaporators 204 and condensers 206. A corresponding set of four water cooled sub-coolers 210a-d (referred to collectively herein as “sub-cooler 210”) are positioned within four water basins 212a-d (referred to collectively herein as “water basin 212”), and below each evaporator 204.

While conventional refrigeration systems may be optimized for cooling the air in a chamber, water production systems are optimized for production of water. Accordingly, one or more water cooled sub-coolers of the present invention may be desirable to increase the efficiency of the water production system.

In embodiments having more than one evaporator and condenser, it may also be desirable to connect the evaporators to the refrigeration system in parallel, and yet connect the condensers to the refrigeration system in series. In this case, the refrigeration system may be arranged to cause the refrigerant to exit the first condenser in a gaseous state, and to exit the second condenser in a liquid state, such that the first condenser acts as a de-superheater.

Water production systems of the present invention may also be provided with an ice sensor capable of sensing ice buildup on an evaporator, and a switch coupled with the ice sensor to shut off the refrigeration system when ice is present, with the air movement device remaining in operation.

In operation of the water production systems of the present invention, a method of extracting water from air may include, for example, providing an air duct having an entry port, an intermediate port, and an exit port; providing an air movement device; and providing a refrigeration system including a cooling element. The method may also include operating the air movement device to cause air to flow along a first and second air flow path. The first flow path may be into the entry port, through the cooling element, and out the exit port, while the second flow path may be into the intermediate port, and out the exit port, thus bypassing the cooling element. The method according to the present invention may further include operating the refrigeration system to cause the cooling element to maintain a temperature of at most a dew point of air contacting the cooling element. The present invention may also include condensing liquid water on an exterior surface of the cooling element, and collecting the liquid water.

In the method of the present invention, a bypass valve may further be provided, and may also include determining a temperature of the air, opening the bypass valve when the temperature exceeds a selected temperature, and closing the bypass valve when the temperature falls below the selected temperature. The method of the present invention may also include adjusting one or more bypass valves in response to a variety of conditions, inputs or sensors, including for example a thermometer, clock, timer, humidity sensor, rain sensor, light sensor, etc.

In a specific example embodiment of the present invention, a water production system may be provided as shown FIGS. 4-9, with various components being selected as follows: two matching refrigeration systems, each having a 5 hp compressor, a pair of evaporators with an air flow capacity of 100 pounds of air per minute, a pair of water cooled sub-coolers, a pair of expansion valves, and a pair of condensers with an air flow capacity of 200 pounds of air per minute. The fan was selected having a capacity of 200 pounds of air per minute, and adjustable bypass valves were provided with a controller set to open them above an ambient air temperature selected at 78 degrees Fahrenheit, or 25.6 degrees Celsius. The resulting example embodiment produced approximately 0.5 liters of water per minute.

Another embodiment of the present invention may involve constructing a water production system with tubing and other components of one or more materials which resist accumulation of bacteria. Examples may include conduits from a water inlet to a pump inlet, from a pump outlet to a water chiller component, and from a chiller component to a water filter. In other words, all plumbing pieces contacting the collected water may be composed of tubing which resists contamination, for example HPC bacteria. One possible material that may exhibit such an advantage is copper, and using copper tubing may be advantageous.

Several advantages may be achieved with the present invention, including for example enhanced efficiency, lowering the amount of energy used to produce a specific amount of water when operating the water production system. Another advantage of the present invention includes broadening the possible environments, geographical areas, weather conditions, and times of day when the water production system of the present invention may be used effectively and efficiently.

It should be understood that an unlimited number of configurations for the present invention could be realized. The foregoing discussion describes merely exemplary embodiments illustrating the principles of the present invention, the scope of which is recited in the following claims. In addition, unless otherwise stated, all of the accompanying drawings are not to scale. Those skilled in the art will readily recognize from the description, claims, and drawings that numerous changes and modifications can be made without departing from the spirit and scope of the invention.

What is claimed is:

1. An apparatus for extracting water from air, the apparatus comprising:
a refrigeration system defining a closed-loop path for a refrigerant, the refrigeration system including:
an evaporator operable to cause liquid water to condense on an exterior surface of the evaporator; and
a sub-cooler;
a water basin defining an inner volume and positioned proximate to the evaporator for collecting water from the exterior surface of the evaporator;
the sub-cooler being positioned inside the inner volume of the water basin.

2. The apparatus according to claim 1, further comprising a water-level maintaining mechanism operable to maintain an amount of water in the water basin so that the sub-cooler remains submerged in the collected water during operation.

3. The apparatus according to claim 2, further comprising a water collection vessel, the water-level maintaining mechanism comprised of a drain tube having an inlet port and an outlet port, the inlet port being positioned within the inner volume of the water basin at a vertical position above the sub-cooler, and the outlet port opening into the water collection vessel.

4. The apparatus according to claim 1, wherein the sub-cooler includes a conduit with a convoluted shape.

5. The apparatus according to claim 1, wherein the refrigeration system further comprises an expansion valve, a compressor, and a condenser.

6. The apparatus according to claim 5, wherein the closed-loop path for the refrigerant is defined by the expansion valve, evaporator, compressor, condenser, and sub-cooler each being coupled sequentially.

7. The apparatus according to claim 6, wherein the refrigeration system further includes a de-superheater coupled in the closed-loop path between the compressor and the condenser.

8. The apparatus according to claim 1, wherein the sub-cooler operates as a reservoir for liquid refrigerant.

9. The apparatus according to claim 8, wherein the refrigeration system further comprises a thermostatic expansion valve operable to draw liquid refrigerant from the sub-cooler.

10. The apparatus according to claim 5, further comprising an additional evaporator, an additional expansion valve and an additional condenser, a refrigerant in the refrigeration system passing sequentially from the compressor to the condenser, to the additional condenser, to the sub-cooler, to the expansion valves, to the evaporator and the additional evaporator, and then returning to the compressor.

11. The apparatus according to claim 10, wherein the evaporator and additional evaporator are connected to the refrigeration system in parallel, and the condenser and additional condenser are connected to the refrigeration system in series.

12. The apparatus according to claim 10, wherein a refrigerant in the refrigeration system exits the condenser in a gaseous state and exits the additional condenser in a liquid state, such that the condenser operates as a de-superheater.

13. The apparatus according to claim 1, further comprising a water collection vessel, as well as an ozonator and an ozone diffuser for purifying the liquid water in the water collection vessel.

14. The apparatus according to claim 1, further comprising a water collection vessel and an overflow system, the overflow system shutting off the refrigeration system when a predetermined amount of water is present the water collection vessel.

15. The apparatus according to claim 5, further comprising a second refrigeration system, the second refrigeration system including a second expansion valve, a second evaporator, a second compressor, a second condenser, and a second sub-cooler, wherein the first and second refrigeration systems define separate closed-loop refrigerant paths.

16. An apparatus for extracting water from air, the apparatus comprising:
a refrigeration system defining a closed-loop path for a refrigerant, the refrigeration system including:
an expansion valve;
an evaporator operable to cause liquid water to condense on an exterior surface of the evaporator;
a compressor;
a de-superheater;
a condenser; and
a sub-cooler;
a water basin positioned proximate to the evaporator for collecting water, the sub-cooler being positioned within the water basin such that the sub-cooler is submerged in collected water during operation; and
a water-level maintaining mechanism, operable to maintain a predetermined amount of collected water in the water basin.

17. A method of extracting water from air using a water production system, the water production system including a water basin, and a refrigeration system having a cooling element and a sub-cooler, the method comprising:
causing air to flow and contact the cooling element;
operating the refrigeration system to cause the cooling element to maintain a temperature of at most a dew point of air contacting the cooling element;
condensing liquid water from the air on an exterior surface of the cooling element; and
collecting the liquid water to submerge the sub-cooler in water in the water basin.

18. The method according to claim 17, wherein the water production system also includes a water collection vessel, the method further comprising:
selecting a desired minimum amount of water in the water basin to submerge the sub-cooler; and
allowing additional water in excess of the selected minimum amount to escape the water basin and collect in the water collection vessel.

19. The method according to claim 17, wherein the cooling element is an evaporator and the water production system further comprises an additional condenser, a refrigerant in the refrigeration system exiting the condenser in a gaseous state and exiting the additional condenser in a liquid state, such that the condenser operates as a de-superheater.

20. The method according to claim 17, wherein the refrigeration system also includes a thermostatic expansion valve in fluid communication with the sub-cooler and a refrigerant, wherein operating the refrigeration system causes the refrigerant to experience a vapor compression cycle and flow through the cooling element, sub-cooler and thermostatic expansion valve, the method further comprising:
maintaining liquid refrigerant in the sub-cooler; and
drawing an amount of the liquid refrigerant from the sub-cooler through the thermostatic expansion valve, the amount corresponding to a temperature of the cooling element.
